(19) United States
(12) Patent Application Publication
(10) Pub. No.: US 2023/0358136 A1
(43) Pub. Date: Nov. 9, 2023

(54) INTEGRATED METHOD FOR MINERALIZING AND SEQUESTRATING CARBON DIOXIDE AND FILLING GOAF WITH FLY ASH

(71) Applicant: Chongqing University, Chongqing (CN)

(72) Inventors: Binwei XIA, Chongqing (CN); Jiansong PENG, Chongqing (CN); Junping ZHOU, Chongqing (CN); Xingguo ZHANG, Chongqing (CN); Jiren TANG, Chongqing (CN); Lei ZHOU, Chongqing (CN); Zhaolong GE, Chongqing (CN); Wenchuan LIU, Chongqing (CN); Weijie GUO, Chongqing (CN)

(21) Appl. No.: 18/313,810

(22) Filed: May 8, 2023

(30) Foreign Application Priority Data
May 9, 2022 (CN) 202210496567.7

(51) Int. Cl. E21F 15/00; G06F 30/28

(52) U.S. Cl. CPC E21F 15/005; G06F 30/28

(57) ABSTRACT

Disclosed is an integrated method for mineralizing and sequestrating carbon dioxide and filling goaf with fly ash, which relates to the engineering field of combination of fly ash and carbon dioxide recycling. The method includes: S1, selecting an area conducive to sequestration of the carbon dioxide; S2, building a stope overburden pressure calculation model in the selected area, to determine a key stratum of a stope and calculate a limit caving interval of an overlying stratum of the stope; S3, mining a coal seam of the stope, and filling the goaf, manufactured by mining the coal seam, with gangue in the coal seam; S4, fully stirring, by a stirring apparatus, the fly ash to form loose fly ash, outputting the loose fly ash to the goaf for filling, and determining an effective flow radius of the carbon dioxide by means of a built carbon dioxide seepage model; and S5, reasonably setting an interval of a vertical drilling well according to the effective flow radius of the carbon dioxide. The present disclosure provides an excellent environment for stacking waste fly ash and sequestrating carbon dioxide.

### CROSS REFERENCE TO RELATED APPLICATION

This patent application claims the benefit and priority of Chinese Patent Application No. 202210496567.7, filed with the China National Intellectual Property Administration on May 9, 2022, the disclosure of which is incorporated by reference herein in its entirety as part of the present application.

### TECHNICAL FIELD

The present disclosure relates to the engineering field of combination of fly ash and carbon dioxide recycling, and in particular to an integrated method for mineralizing and sequestrating carbon dioxide and filling goaf with fly ash.

### BACKGROUND

According to global statistical data, coal-fired power plants in China dominate production of fly ash that accounts for more than 50% of production in the world. Global economic development has promoted the production of the fly ash year by year. The fly ash belongs to industrial solid waste. The coal-fired power plants in different regions vary in production and utilization of the fly ash. Currently, such industrial solid waste is still dumped, resulting in problems to some extent, such as occupation of land, pollution of soil and water resources, harm to an environment and waste of resources. Accordingly, it is urgent to seek a method to develop and utilize the industrial solid waste.

Development of world economy has intensified utilization of natural resources. As a result, a large amount of waste gas is generated during use, resulting in a greenhouse effect, to which human survival and development are seriously tied. The greenhouse effect induces global climate warming, glacier melting, sea level rise and other adverse environmental problems, and consequently extreme weather is becoming increasingly frequent. Natural evolutionary laws do not cause such global climate changes, which are closely related to human life. Since an industrial evolution, use of fossil fuels has intensified emissions of carbon dioxide. According to related data from World Environmental Organization, emissions of global carbon dioxide accounted for more than 68% of total emissions of greenhouse gas in 2020. However, a natural environment has little effect on absorption treatment of carbon dioxide compared with human emissions. In view of that, it is a problem urgently to be solved in the world to control the emissions of the carbon dioxide.

Serving as a big country of coal production and consumption in the world, China needs huge energy resources to support economic development, thereby intensifying exploitation of coal resources. Long-term large-scale mining renders a wide range of waste coal mines and goaf. However, a crustal stress is disturbed by formation of the waste coal mines and the goaf. Continuous advance of a coal working face has intensified impact of disturbance, resulting in deformation of surrounding rock, and roof separation, rupture and caving. Current goaf filling has the problems of an insufficient filling raw material and a poor filling effect, resulting in ground subsidence and collapse. In view of that, it is a problem to be urgently solved to fill the waste coal mines and the goaf to reduce ground subsidence and collapse, strong rock pressure appearance, rock burst, and strong impact airflow caused by roof caving.

### SUMMARY

The present disclosure provides an integrated method for mineralizing and sequestrating carbon dioxide and filling goaf with fly ash. The goaf is filled with waste mineralized fly ash loose materials and gangue to have an effect of supporting and protecting an overlying stratum of the goaf, so as to prevent the overlying stratum from being broken and caving, thereby solving disaster problems of goaf settlement and collapse, strong pressure appearance, etc.; moreover, a closed space container is formed by the goaf, thereby solving the problems that waste fly ash is placed and gangue does not need to be discharged of a well, and reducing waste of land resources and pollution of an environment; and the carbon dioxide is mineralized repeatedly in a process from manufacturing the loose materials to filling the goaf, thereby solving the problem of long-term safe sequestration of carbon dioxide to a great extent, reducing emissions of the carbon dioxide, and reducing a greenhouse effect.

The present disclosure is implemented by means of the following technical solution:

an integrated method for mineralizing and sequestrating carbon dioxide and filling goaf with fly ash includes the following steps:
S1, selecting an area conducive to sequestration of the carbon dioxide;
S2, building a stope overburden pressure calculation model in the selected area, to determine a key stratum of a stope and calculate a limit caving interval of an overlying stratum of the stope;
S3, mining a coal seam of the stope, and simultaneously filling the goaf, manufactured by mining the coal seam, with gangue in the coal seam;
S4, fully stirring, by a stirring apparatus, the fly ash to form loose fly ash, outputting the loose fly ash to the goaf for filling, and determining an effective flow radius of the carbon dioxide by means of a built carbon dioxide seepage model;
S5, reasonably setting an interval of a vertical drilling well according to the effective flow radius of the carbon dioxide, and sequentially conveying, by means of a conveying pipeline, the carbon dioxide in a carbon dioxide storage tank into the goaf from the vertical drilling well, to perform a re-mineralization reaction with the gangue and the loose fly ash.

Preferably, the area conducive to sequestration of the carbon dioxide at least satisfies the following conditions: a sequestration space has a large capacity, excellent sealing performance, a stable stratum, no undeveloped structure, a low-permeability cover stratum, a lens, a thick reservoir and excellent overall integrity.

Preferably, the building a stope overburden pressure calculation model in a selected area, to determine a key stratum of a stope and calculate a limit caving interval of an overlying stratum of the stope in S2 specifically includes:

implementing, by means of the stope overburden pressure calculation model built by considering twelve parameters, a programmed calculation model with fast lagrangian analysis of continua in three-dimensions (FLAC3D) simulation software, and determining the key stratum by analyzing a pressure of each stratum in the overlying stratum of the stope on the coal seam of a working face,

where the limit caving interval is expressed as follows:

$${L}_{T} = 2 h \sqrt{\frac{{R}_{T}}{3 {σ}_{vi}}} ,$$

and

the stope overburden pressure calculation model is expressed as follows:

where β indicates an included angle between a broken line of a rock stratum and the coal seam, L indicates an advancing length of the working face, in m, φ indicates an internal friction angle of rock, in °, Iₚ indicates a periodic breaking interval of an i-th layer of rock beam, in m, rᵢ indicates a unit weight of the i-th layer of rock beam, in N/m³, hᵢ indicates a thickness of the i-th layer of rock beam, in m, E indicates an elastic modulus of the rock beam, in Pa, I indicates moment of inertia of a cross section of the rock beam, in m⁴, H_{f} indicates a height of a fractured zone, in m, k indicates a coefficient of breaking expansion, Hᵢ indicates a distance between an i-th layer of rock stratum and the coal seam, in m, x indicates a distance from a lead coal wall, in m, σvi indicates a vertical stress of the i-th layer of rock stratum acting on a wedge, in Pa, RT indicates a limit tensile strength, L_{T} indicates the limit caving interval, in m, Hc indicates a limit caving height, in m, Lc indicates an advancing length of the critical working face, in m, and

$$α = \sqrt[4]{K / 4 EI} .$$

Preferably, the fully stirring, by a stirring apparatus, the fly ash to form loose fly ash in S4 includes:
S4.1, adding waste fly ash into a stirring chamber of the stirring apparatus by means of a hopper container, and adding, by means of the hopper container, solute in a certain proportion to the fly ash into the stirring chamber for mixing and stirring in a closed environment under a certain constant temperature condition (50° C.);
S4.2, opening a valve of the carbon dioxide storage tank, and injecting a certain pressure (1-1.5 MPa) of carbon dioxide into the stirring chamber by means of a first carbon dioxide conveying pipeline;
S4.3, opening a first valve, adding a certain concentration of Na₂CO₃ solution additive into the stirring chamber by means of a liquid conveying pipeline in a solution storage tank, and opening a magnetic stirrer to stir substances to make the substances in the stirring chamber fully react; and
S4.4, determining that the substances in the stirring chamber become loose materials and a pressure value detected by a pressure sensor configured to detect a pressure of the carbon dioxide inside the stirring chamber is no longer changed, and stopping stirring.

Preferably, the carbon dioxide seepage model is expressed as follows:

$$\{ \begin{matrix}\begin{matrix}\begin{matrix}\frac{\partial }{\partial t} \{ p {ϕ}_{0} exp [ - {c}_{t} ( Δσ - Δ p ) ] + \\ {ρ}_{ga} {ρ}_{c} \frac{R T}{{M}_{g}} \frac{a b p}{1 + b p} \frac{1 - 0.01 A - 0.01 W}{1 + 0.31 W} \} = ∇ ( \frac{k}{μ} ∇ p )\end{matrix} \\ p ( 0 , 0 ) = 2\end{matrix} \\ p ( 13 , t ) = 0.08 , ( t > 0 ) \\ {\frac{\partial p}{\partial x} \vert}_{x = 13} = 0 , ( t > 0 )\end{matrix} ,$$

where t indicates flow time of the injected carbon dioxide, in h, p indicates the pressure of the carbon dioxide, in Pa, Ø₀ indicates porosity of a compacted solid, Cₜ indicates a compression coefficient, Δσ indicates a confining pressure difference, in Pa, Δp indicates an air pressure difference, in Pa, ρ_{ga} indicates a gas density under a standard condition, in g/cm³, ρ_{c} indicates a solid density, in g/cm³, A indicates an ash content, W indicates a moisture content, k indicates permeability of the carbon dioxide, in mD, μ indicates a viscosity coefficient of the carbon dioxide, x indicates a real-time flow distance of the carbon dioxide, a and b indicate adsorption constants respectively, R indicates an ideal gas constant, T indicates an environment temperature, in ° C., and Mg indicates molar mass of gas.

Preferably, the method further includes S6, conveying the loose fly ash, simultaneously feeding back, by means of a range finder, a monitored signal of a distance from a filler consisting of the loose fly ash and the gangue in the goaf to a wellbore to a controller in real time, and determining, by the controller, whether filling is completed.

Preferably, in S4, the loose fly ash is output to the goaf by output power provided by means of a pulsation pump, and by means of the loose material conveying pipeline, the loose fly ash is conveyed into the goaf from the vertical drilling well for filling.

Preferably, the fly ash includes, but not limited to, waste fly ash from a coal-fired power plant.

Preferably, the carbon dioxide is produced from one or more of waste gas from a coal-fired power plant, waste gas from an iron and steel plant, and waste gas from a chemical plant.

Preferably, the solute is tap water.

Compared with the prior art, the present disclosure has the following advantages and beneficial effects:
1. The present disclosure performs mining by using a spaced coal pillar, and fills the goaf with the waste gangue while performing mining, and has effects of protecting the overlying stratum from being broken and caving and supporting the overlying stratum compared with a traditional method for destroying an overlying stratum, such that a closed stratum is formed by the overlying stratum, and a closed bin is formed by the goaf, thereby providing an excellent environment for stacking waste fly ash and sequestrating the carbon dioxide.
2. The present disclosure may perform secondary mineralization on the carbon dioxide in a process from manufacturing the loose fly ash to filling the goaf, and may safely sequestrate the carbon dioxide for a long time, thereby greatly reducing emissions of the carbon dioxide, and effectively reducing a greenhouse effect.
3. The goaf is filled with the fly ash and the gangue, thereby solving placement of the waste fly ash, reducing waste of land resources and pollution of an environment, and further making up for shortage of a current filling raw material, and achieving the purpose that the gangue does not need to be discharged out of a well; and moreover, disaster conditions such as ground subsidence and collapse, strong mine pressure appearance, rock burst and strong impact airflow caused by roof caving may be reduced by filling the goaf.

### BRIEF DESCRIPTION OF THE DRAWINGS

In order to describe technical solutions of implementations of the present disclosure more clearly, accompanying drawings required for the embodiments are briefly described below. Apparently, the following accompanying drawings show merely some embodiments of the present disclosure, and therefore should not be regarded as the limitations to the scope. Those of ordinary skill in the art may further derive other relevant accompanying drawings from these accompanying drawings without creative efforts. In the figures:

FIG. 1 is a schematic structural diagram of a stirring system used in an integrated method for mineralizing and sequestrating carbon dioxide and filling goaf with fly ash according to the present disclosure;

FIG. 2 is a schematic diagram of an effective flow radius of a carbon dioxide seepage model.

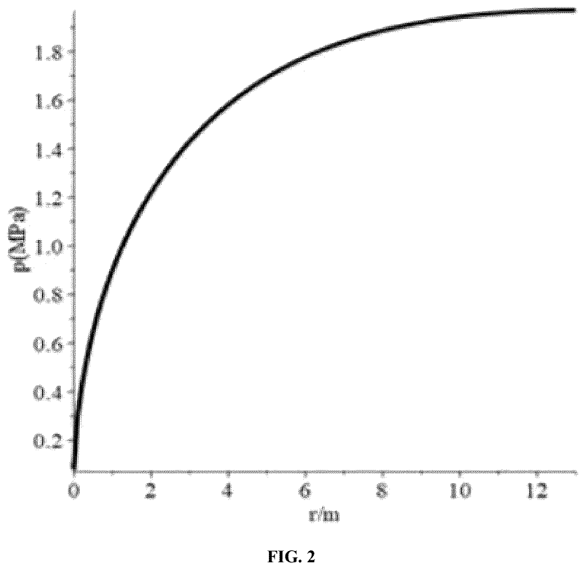

### REFERENCE NUMERALS

1—liquid storage tank; 2—first valve; 3—first pressure gauge; 4—liquid conveying pipeline; 5—raw material conveying pipeline; 6—second valve; 7—hopper container; 8—heating pack; 9—slurry; 10—magnetic stirrer; 11—flow meter; 12—second pressure gauge; 13—third valve; 14—first carbon dioxide conveying pipeline; 15—carbon dioxide storage tank; 16—pressure sensor; 17—computer system; 18—fourth valve; 19—second carbon dioxide conveying pipeline; 20—controller; 21—controller signal transmission line; 22—fifth valve; 23—loose material conveying pipeline; 24—pulsation pump; 25—range finder; 26—overlying stratum; 27—coal seam; 28—goaf; 29—hydraulic support; and 30—push plate.

### DETAILED DESCRIPTION OF THE EMBODIMENTS

In order to make the objectives, technical solutions and advantages of the present disclosure clearer, the present disclosure will be further described in detail below in combination with the embodiments and the accompanying drawings. The schematic implementations of the present disclosure and descriptions of the schematic implementations are merely intended to explain the present disclosure and are not intended to limit the present disclosure.

### Embodiment

Before the present disclosure is described in detail, a stirring system used in the present disclosure will be described.

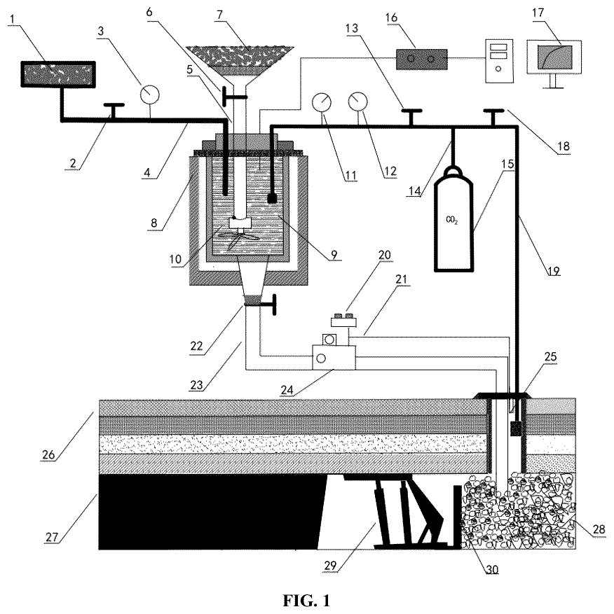

As shown in FIG. 1, a stirring system includes a liquid storage tank 1, a liquid conveying pipeline 4, a first valve 2, a first pressure gauge 3, a hopper container 7, a second valve 6, a raw material conveying pipeline 5, a carbon dioxide storage tank 15, a first carbon dioxide conveying pipeline 14, a third valve 13, a second pressure gauge 12, a flow meter 11, a fourth valve 18, a second carbon dioxide conveying pipeline 19, a magnetic stirrer 10, loose fly ash 9, a heating pack 8, a pressure sensor 16, a computer system 17, a valve 22, a loose material conveying pipeline 23, a pulsation pump 24, a controller 20, a controller signal transmission line 21 and a range finder 25. The liquid conveying pipeline 4 is connected to the liquid storage tank 1, the first valve 2 and the first pressure gauge 3, the raw material conveying pipeline 5 is connected to the hopper container 7, the second valve 6 and the magnetic stirrer 10, the second carbon dioxide conveying pipeline 19 is connected to the carbon dioxide storage tank 15, the fourth valve 18, the third valve 13, the second pressure gauge 12 and the flow meter 11, and the loose material conveying pipeline 23 is connected to the fifth valve 22, the pulsation pump 24, the controller 20, the controller signal transmission line 21 and the range finder 25.

The computer system 17 and the pressure sensor 16 are connected to each other by means of a line, to extend into the magnetic stirrer.

The conveying pipelines (4, 5, 19) and the pressure sensor 16 extend into the magnetic stirrer by means of a high-pressure cover.

The conveying pipelines (23, 19) and the controller signal transmission line 21 extend into the goaf by means of a vertical drilling well.

An outlet end of the loose material conveying pipeline and the second carbon dioxide conveying pipeline 19 extend into the goaf at a certain height from a filler, so as to facilitate conveying and flow distribution of loose materials, and both the loose materials and carbon dioxide are injected into the goaf.

The range finder is arranged at a wellbore.

Next, specific implementations of the present disclosure are described in detail.

The present disclosure discloses an integrated method for mineralizing and sequestrating carbon dioxide and filling goaf with fly ash. The integrated method includes:
S1, select an area conducive to sequestration of the carbon dioxide.

In the embodiment, the area conducive to sequestration of the carbon dioxide at least satisfies the following conditions: a sequestration space has a large capacity, excellent sealing performance, a stable stratum, no undeveloped structure (which refers to small deformation of a rock stratum and a rock mass forming a crust under internal and external geological actions), a low-permeability cover stratum, a lens, a thick reservoir and excellent overall integrity.

By utilizing the above conditions, the area conducive to sequestration of the carbon dioxide is selected by means of a multi-scale target approximation method. A specific location selection indicator system of the area is shown in Table 1.

TABLE 1

| Indicator | | Indicator | | |
|---|---|---|---|---|
| layer | Weight | sublayer | Weight | Evaluation |
| Location | 0.40 | Reservoir body | 0.51 | Permeability, . . . |
| selection | | condition | | |
| technical | | Storage | 0.26 | Effective storage capacity, |
| factor | | potential | | storage life . . . |
| | | Stratum | 0.13 | Injection layer pressure |
| | | pressure | | |
| | | Stratum | 0.03 | Ground temperature gradient, |
| | | temperature | | ground heat flow value . . . |
| | | Filling and | 0.07 | Filling index, injection |
| | | sequestrating | | amount, injection speed . . . |
| | | technology | | |
| Geological | 0.30 | Sealing | 0.63 | Macroscopic development |
| safety | | performance of | | feature of cover stratum, |
| factor | | cover stratum | | quantitative sealing index of |
| | | | | cover stratum |
| | | Crustal | 0.26 | Development of active fault, |
| | | stability | | earthquake safety . . . |
| | | Ground | 0.11 | Collapse, landslide . . . |
| | | geological | | |
| | | disaster | | |
| | | susceptibility | | |
| Economic | 0.20 | Filling and | 0.06 | Carbon dioxide cost |
| factor | | sequestrating | | |
| | | cost | | |
| | | Source and | 0.26 | Carbon source scale, carbon |
| | | sink cost | | source distance . . . |
| | | Infrastructure | 0.12 | Mode of transportation, |
| | | | | traffic condition |
| | | Resource | 0.56 | Coal seam, geotherm . . . |
| | | occupation | | |
| | | condition | | |
| Ground | 0.10 | Public social | 0.67 | Population density, public |
| environmental | | environment | | recognition . . . |
| protection | | Geographical | 0.33 | Geographical location, |
| condition | | condition of | | distance from sensitive area |
| factor | | site | | |

S2, build a stope overburden pressure calculation model in the selected area, to determine a key stratum of a stope and calculate a limit caving interval of an overlying stratum of the stope.

By means of the stope overburden pressure calculation model built by considering twelve parameters, a programmed calculation model is implemented with fast lagrangian analysis of continua in three-dimensions (FLAC3D) simulation software, and the key stratum is determined by analyzing a pressure of each stratum in the overlying stratum of the stope on the coal seam of a working face,

where the limit caving interval is expressed as follows:

$${L}_{T} = 2 h \sqrt{\frac{{R}_{T}}{3 {σ}_{vi}}} ,$$

and

the stope overburden pressure calculation model is expressed as follows:

where β indicates an included angle between a broken line of a rock stratum and the coal seam, L indicates an advancing length of the working face, in m, φ indicates an internal friction angle of rock, in °, Iₚ indicates a periodic breaking interval of an i-th layer of rock beam, in m, rᵢ indicates a unit weight of the i-th layer of rock beam, in N/m³, hᵢ indicates a thickness of the i-th layer of rock beam, in m, E indicates an elastic modulus of the rock beam, in Pa, I indicates moment of inertia of a cross section of the rock beam, in m⁴, H_{f} indicates a height of a fractured zone, in m, k indicates a coefficient of breaking expansion, Hᵢ indicates a distance between an i-th layer of rock stratum and the coal seam, in m, x indicates a distance from a lead coal wall, in m, σvi indicates a vertical stress of the i-th layer of rock stratum acting on a wedge, in Pa, RT indicates a limit tensile strength, L_{T} indicates the limit caving interval, in m, Hc indicates a limit caving height, in m, Lc indicates an advancing length of the critical working face, in m, and

$$α = \sqrt[4]{K / 4 EI} .$$

Based on the above stope overburden pressure calculation model, the limit caving interval may be quickly and conveniently obtained.
S3, mine a coal seam of the stope, and simultaneously fill the goaf, manufactured by mining the coal seam, with gangue in the coal seam.

The goaf is filled with the gangue mined from the coal seam while the coal seam is mined, simultaneous mining and filling supports the overlying stratum in the goaf, and prevents damage and caving of the overlying stratum to protect the key stratum, such that a closed stratum is formed by the overlying stratum, thereby providing conditions for filling the fly ash and mineralizing and sequestrating the carbon dioxide.
S4, fully stir, by a stirring apparatus, the fly ash to form loose fly ash, output the loose fly ash to the goaf for filling, and determine an effective flow radius of the carbon dioxide by means of a built carbon dioxide seepage model.

An effective flow distance of the carbon dioxide in the filled goaf may be correctly calculated by building the model, thereby providing a basis for effective hole layout, so as to make the carbon dioxide fully react with solid waste.

In the embodiment, the step of fully stirring, by a stirring apparatus, the fly ash to form loose fly ash includes:
S4.1, open a second valve 6, add waste fly ash into a stirring chamber of the stirring apparatus by means of a hopper container 7, and add, by means of the hopper container 7, solute in a certain proportion to the fly ash into the stirring chamber for mixing and stirring in a closed environment under a certain constant temperature condition (50° C.), where the solute may be, but not limited to, tap water, which may come from tap water near the goaf, and is convenient to take;
S4.2, open a valve of the carbon dioxide storage tank 15, open a third valve 13, and inject a certain pressure (1-1.5 MPa) of carbon dioxide into the stirring chamber by means of a first carbon dioxide conveying pipeline 14;
S4.3, open a first valve 2, add a certain concentration of Na₂CO₃ solution additive into the stirring chamber by means of a liquid conveying pipeline 4 in a solution storage tank 1, and open a magnetic stirrer 10 to stir substances to make the substances in the stirring chamber fully react; and
S4.4, determine that the substances in the stirring chamber become loose materials and a pressure value detected by a pressure sensor 16 configured to detect a pressure of the carbon dioxide inside the stirring chamber is no longer changed, and stop stirring; and
S4.5, open a fifth valve 22 and a pulsation pump 24, and provide output power by means of the pulsation pump 24 to convey, by means of a loose material conveying pipeline 23, the loose fly ash into the goaf from the vertical drilling well for filling.

In the embodiment, the carbon dioxide seepage model is expressed as follows:

$$\{ \begin{matrix}\begin{matrix}\begin{matrix}\frac{\partial }{\partial t} \{ p {ϕ}_{0} exp [ - {c}_{t} ( Δσ - Δ p ) ] + \\ {ρ}_{ga} {ρ}_{c} \frac{R T}{{M}_{g}} \frac{a b p}{1 + b p} \frac{1 - 0.01 A - 0.01 W}{1 + 0.31 W} \} = ∇ ( \frac{k}{μ} ∇ p )\end{matrix} \\ p ( 0 , 0 ) = 2\end{matrix} \\ p ( 13 , t ) = 0.08 , ( t > 0 ) \\ {\frac{\partial p}{\partial x} \vert}_{x = 13} = 0 , ( t > 0 )\end{matrix}$$

where t indicates flow time of the injected carbon dioxide, in h, p indicates the pressure of the carbon dioxide, in Pa, Ø₀ indicates porosity of a compacted solid, Cₜ indicates a compression coefficient, Δσ indicates a confining pressure difference, in Pa, Δp indicates an air pressure difference, in Pa, ρ_{ga} indicates a gas density under a standard condition, in g/cm³, ρ_{c} indicates a solid density (a density of a mixture of the fly ash and the gangue is calculated by sampling and measurement of mass and volume in a laboratory), in g/cm³, A indicates an ash content, W indicates a moisture content, k indicates permeability of the carbon dioxide, in mD, μ indicates a viscosity coefficient of the carbon dioxide, x indicates a real-time flow distance of the carbon dioxide, a and b indicate adsorption constants respectively, R indicates an ideal gas constant, T indicates an environment temperature, in ° C., and Mg indicates molar mass of gas.

The effective flow distance of the carbon dioxide in the filled goaf may be correctly calculated by building the model, thereby providing a basis for effective hole layout, so as to make the carbon dioxide fully react with the solid waste. Compared with a traditional model, the carbon dioxide seepage model considers an effect of the effective stress, is more suitable for actual conditions of an engineering site, and may more accurately determine the effective flow radius.
S5, reasonably set an interval of a vertical drilling well according to the effective flow radius of the carbon dioxide, and sequentially convey, by means of a conveying pipeline, the carbon dioxide in a carbon dioxide storage tank into the goaf from the vertical drilling well, to perform a re-mineralization reaction with the gangue and the loose fly ash.

In the embodiment, the method further includes S6, convey the loose fly ash, simultaneously feed back, by means of a range finder, a monitored signal of a distance from a filler consisting of the loose fly ash and the gangue in the goaf to a wellbore to a controller in real time, determine, by the controller, whether filling is completed, remove a mixing system after completion, seal the drilling well, and then repeat the above steps for next goaf.

In the embodiment, the fly ash includes, but not limited to, waste fly ash from a coal-fired power plant.

In the embodiment, the carbon dioxide is produced from one or more of waste gas from a coal-fired power plant, waste gas from an iron and steel plant, and waste gas from a chemical plant.

The objectives, the technical solutions and the beneficial effects of the present disclosure are further described in detail by means of the above specific implementation, and it should be understood that what is described above is only the specific implementation of the present disclosure and is not intended to define the scope of protection of the present disclosure. Any modifications, equivalent substitutions, improvements, etc. within the spirit and principles of the present disclosure are intended to be encompassed within the scope of protection of the present disclosure.

What is claimed is:

1. An integrated method for mineralizing and sequestrating carbon dioxide and filling goaf with fly ash, comprising:
S1, selecting an area conducive to sequestration of the carbon dioxide;
S2, building a stope overburden pressure calculation model in the selected area, to determine a key stratum of a stope and calculate a limit caving interval of an overlying stratum of the stope;
S3, mining a coal seam of the stope, and simultaneously filling the goaf, manufactured by mining the coal seam, with gangue in the coal seam;
S4, fully stirring, by a stirring apparatus, the fly ash to form loose fly ash, outputting the loose fly ash to the goaf for filling, and determining an effective flow radius of the carbon dioxide by means of a built carbon dioxide seepage model; and
S5, reasonably setting an interval of a vertical drilling well according to the effective flow radius of the carbon dioxide, and sequentially conveying, by means of a conveying pipeline, the carbon dioxide in a carbon dioxide storage tank into the goaf from the vertical drilling well, to perform a re-mineralization reaction with the gangue and the loose fly ash.

2. The integrated method for mineralizing and sequestrating carbon dioxide and filling goaf with fly ash according to claim 1, wherein the area conducive to sequestration of the carbon dioxide at least satisfies the following conditions: a sequestration space has a large capacity, excellent sealing performance, a stable stratum, no undeveloped structure, a low-permeability cover stratum, a lens, a thick reservoir and excellent overall integrity.

3. The integrated method for mineralizing and sequestrating carbon dioxide and filling goaf with fly ash according to claim 1, wherein the building a stope overburden pressure calculation model in a selected area, to determine a key stratum of a stope and calculate a limit caving interval of an overlying stratum of the stope in S2 specifically comprises:
implementing, by means of the built stope overburden pressure calculation model, a programmed calculation model with fast lagrangian analysis of continua in three-dimensions (FLAC3D) simulation software, and determining the key stratum by analyzing a pressure of each stratum in the overlying stratum of the stope on the coal seam of a working face,
wherein the limit caving interval is expressed as follows:
$${L}_{T} = 2 h \sqrt{\frac{{R}_{T}}{3 {σ}_{vi}}} ,$$
and the stope overburden pressure calculation model is expressed as follows: [symbol]
where β indicates an included angle between a broken line of a rock stratum and the coal seam, L indicates an advancing length of the working face, in m, φ indicates an internal friction angle of rock, in °, Iₚ indicates a periodic breaking interval of an i-th layer of rock beam, in m, rᵢ indicates a unit weight of the i-th layer of rock beam, in N/m³, hᵢ indicates a thickness of the i-th layer of rock beam, in m, E indicates an elastic modulus of the rock beam, in Pa, I indicates moment of inertia of a cross section of the rock beam, in m⁴, H_{f} indicates a height of a fractured zone, in m, k indicates a coefficient of breaking expansion, Hᵢ indicates a distance between an i-th layer of rock stratum and the coal seam, in m, x indicates a distance from a lead coal wall, in m, σvi indicates a vertical stress of the i-th layer of rock stratum acting on a wedge, in Pa, RT indicates a limit tensile strength, L_{T} indicates the limit caving interval, in m, Hc indicates a limit caving height, in m, Lc indicates an advancing length of the critical working face, in m, and
$$α = \sqrt[4]{K / 4 EI} .$$

4. The integrated method for mineralizing and sequestrating carbon dioxide and filling goaf with fly ash according to claim 1, wherein the fully stirring, by a stirring apparatus, the fly ash to form loose fly ash in S4 comprises:
S4.1, adding waste fly ash into a stirring chamber of the stirring apparatus by means of a hopper container, and adding, by means of the hopper container, solute in a certain proportion to the fly ash into the stirring chamber for mixing and stirring in a closed environment under a certain constant temperature condition;
S4.2, opening a valve of the carbon dioxide storage tank, and injecting a certain pressure of carbon dioxide into the stirring chamber;
S4.3, adding a certain concentration of Na₂CO₃ solution additive into the stirring chamber by means of a solution storage tank, and stirring substances to make the substances in the stirring chamber fully react; and
S4.4, determining that the substances in the stirring chamber become loose materials and a pressure value detected by a pressure sensor configured to detect a pressure of the carbon dioxide inside the stirring chamber is no longer changed, and stopping stirring.

5. The integrated method for mineralizing and sequestrating carbon dioxide and filling goaf with fly ash according to claim 1, wherein the carbon dioxide seepage model is expressed as follows:
$$\{ \begin{matrix}\begin{matrix}\begin{matrix}\frac{\partial }{\partial t} \{ p {ϕ}_{0} exp [ - {c}_{t} ( Δσ - Δ p ) ] + \\ {ρ}_{ga} {ρ}_{c} \frac{R T}{{M}_{g}} \frac{a b p}{1 + b p} \frac{1 - 0.01 A - 0.01 W}{1 + 0.31 W} \} = ∇ ( \frac{k}{μ} ∇ p )\end{matrix} \\ p ( 0 , 0 ) = 2\end{matrix} \\ p ( 13 , t ) = 0.08 , ( t > 0 ) \\ {\frac{\partial p}{\partial x} \vert}_{x = 13} = 0 , ( t > 0 )\end{matrix} ,$$
wherein t indicates flow time of the injected carbon dioxide, in h, p indicates the pressure of the carbon dioxide, in Pa, Ø₀ indicates porosity of a compacted solid, Cₜ indicates a compression coefficient, Δσ indicates a confining pressure difference, in Pa, Δp indicates an air pressure difference, in Pa, ρ_{ga} indicates a gas density under a standard condition, in g/cm³, ρ_{c} indicates a solid density, in g/cm³, A indicates an ash content, W indicates a moisture content, k indicates permeability of the carbon dioxide, in mD, μ indicates a viscosity coefficient of the carbon dioxide, x indicates a real-time flow distance of the carbon dioxide, a and b indicate adsorption constants respectively, R indicates an ideal gas constant, T indicates an environment temperature, in ° C., and Mg indicates molar mass of gas.

6. The integrated method for mineralizing and sequestrating carbon dioxide and filling goaf with fly ash according to claim 1, further comprising S6, conveying the loose fly ash, simultaneously feeding back, by means of a range finder, a monitored signal of a distance from a filler consisting of the loose fly ash and the gangue in the goaf to a wellbore to a controller in real time, and determining, by the controller, whether filling is completed.

7. The integrated method for mineralizing and sequestrating carbon dioxide and filling goaf with fly ash according to claim 1, wherein in S4, the loose fly ash is output to the goaf by output power provided by means of a pulsation pump, and by means of the conveying pipeline, the loose fly ash is conveyed into the goaf from the vertical drilling well for filling.

8. The integrated method for mineralizing and sequestrating carbon dioxide and filling goaf with fly ash according to claim 1, wherein the fly ash comprises, but not limited to, waste fly ash from a coal-fired power plant.

9. The integrated method for mineralizing and sequestrating carbon dioxide and filling goaf with fly ash according to claim 1, wherein the carbon dioxide is produced from one or more of waste gas from a coal-fired power plant, waste gas from an iron and steel plant, and waste gas from a chemical plant.

10. The integrated method for mineralizing and sequestrating carbon dioxide and filling goaf with fly ash according to claim 1, wherein the solute is tap water.
